(19) United States
(12) Patent Application Publication
(10) Pub. No.: US 2008/0180326 A1
(43) Pub. Date: Jul. 31, 2008

(54) Pendulum-shaped microstrip antenna structure

(75) Inventor: Po-Chuan Chen, Hsinchu (TW)

Correspondence Address: WPAT, PC, 7225 BEVERLY ST., ANNANDALE, VA, 22003, US

(73) Assignee: Alpha Networks Inc., Hsinchu (TW)

(21) Appl. No.: 11/699,384

(22) Filed: Jan. 30, 2007

(51) Int. Cl. H01Q 1/38; H01Q 9/04

(52) U.S. Cl. 343/700 MS

(57) ABSTRACT

The present invention discloses a pendulum-shaped microstrip antenna structure which is manufactured in form of a metal microstrip on a side of the printed circuit board and installed at a distal end of the printed circuit board, when the pendulum-shaped antenna is installed onto a printed circuit board of a wireless electronic product. The pendulum-shaped microstrip antenna structure includes a signal feeding portion and an antenna portion sequentially installed in the direction from the printed circuit board to its distal end, and the pendulum-shaped antenna is extended outward, so that a current transmitted from the pendulum-shaped antenna can be distributed uniformly onto the signal feeding portion and the antenna portion to achieve the effects of improving the bandwidth of the pendulum-shaped antenna, reducing the feeding inductance, and providing sufficient bandwidth for the antenna.

### FIELD OF THE INVENTION

The present invention relates to a microstrip antenna structure, and more particularly to a pendulum-shaped microstrip antenna structure for improving the bandwidth of the antenna, reducing the feeding inductance, and providing sufficient bandwidth.

### BACKGROUND OF THE INVENTION

As present wireless electronic products having a USB interface tend to be developed with a thin, light, short and compact design, the space reserved for an antenna unit in the wireless electronic product becomes increasingly smaller, and thus the position of the antenna unit in the wireless electronic product is very limited. In general, the antenna unit for the wireless electronic product is a chip antenna produced by a low temperature cofired ceramic technology, and the chip antenna has the features of small size and flexibility for its installation in the wireless electronic product. However, the chip antenna cannot be installed onto a circuit board according to the best condition of the practical application, because the chip antenna has to cope with different external mechanisms of the wireless electronic product and coefficients of the circuit board, so that the chip antenna has to employ extra capacitors and inductors. Furthermore, the dielectric coefficient of the chip antenna is too large due to the material of the chip antenna, and thus the problem of having insufficient bandwidth for the application of the chip antenna may arise, and the performance of the chip antenna may be lowered. Chip antennas of this sort require additional costs, and incur a higher overall cost of the wireless electronic product.

Referring to FIGS. 1 and 2 for the radiation performance on the application of a chip antenna, the chip antenna 51 is installed at the upper left of a circuit board 50, and a feed line 53 is extended from the right side of the chip antenna 51 to a ground surface 52 that gives an effect of blocking the radiation pattern of the chip antenna 51, so that the radiation pattern of the chip antenna 51 is deviated slightly to the upper left of the circuit board 50 to give a better directionality. However, the wireless electronic product may have a dead corner in its use; and as a result, the wireless signal cannot be received effectively. Further, the chip antenna 51 must have a sufficient obstacle-free area on the circuit board 50, and thus the design of the wireless electronic product including its size and cost is limited significantly, if the foregoing wireless electronic product with a USB interface has to reserve a sufficient obstacle-free area on the circuit board 50.

Therefore, some designers install an antenna with other geometric shapes including a circular antenna unit (as shown in FIG. 3A) and a polygonal antenna (such as a horn-shaped antenna unit as shown in FIG. 3B) on the circuit board 60, 70 and try to find a feasible solution from these antenna units 61, 71 with various different geometric shapes by providing the most appropriate size and cost of the product. However, it is necessary to take the limitations of the design of the antenna unit 61, 71 and its actual implementation into consideration for the manufacture of such antenna units 61, 71 with different shapes. The limitations include the feasibility of mass production and after-sale maintenance as well as the level of difficulty for adjusting the bandwidth of an antenna unit, and only the horn-shaped antenna unit 71 can accommodate these limitations and fit the application better. In FIGS. 3B and 4, the horn-shaped antenna unit 71 provides an enhanced bandwidth for receiving and transmitting wireless signals, but tests conducted by a network analyzer indicate that the horn-shaped antenna unit 71 has a good frequency response at the bandwidths of 3372 MHz and 4596 MHz, but it cannot meet the requirement of maintaining an average standard below −10.00 dB at the bandwidths of 3100 MHz and 4800 MHz as specified in the wireless USB specification. If it is necessary to improve the bandwidth performance of the horn-shaped antenna unit 71, the area of the antenna unit 71 on the circuit board 70 and the cost of the antenna unit 71 must be increased, and thus making it very difficult for manufacturers to control the cost.

As to the traditional feeding method for an antenna unit, a feed line 62, 72 of a single microstrip line (as shown in FIGS. 3A and 3B) feeds the antenna unit 61, 71, and its advantages include a simple structure and an easy design. For a better quality of the antenna, designers replaces the single feed line by a multi-channel feed line 82 to feed the antenna unit 81 simultaneously without changing the existing structure of the antenna unit 81 as shown in FIG. 5, so as to overcome the shortcomings of uneven distribution of current at the antenna unit 81 and insufficient bandwidth. However, the design of a multi-channel feed line 82 is relatively difficult, and requires accurate estimations on the interactive coupling effect of the microstrip line and any change brought by the impedance of the microstrip line. Therefore, it is an important issue for antenna designers and manufacturers to develop a microstrip antenna structure to overcome the aforementioned shortcomings.

### SUMMARY OF THE INVENTION

In view of the foregoing shortcomings of the prior art, the inventor of the present invention based on years of experience in the related industry to conduct extensive researches and experiments, and finally developed a pendulum-shaped microstrip antenna structure in accordance with the present invention.

Therefore, it is a primary objective of the present invention to provide a pendulum-shaped microstrip antenna structure, and the pendulum-shaped antenna is manufactured in form of a metal microstrip on a side of the printed circuit board and installed at a distal end of the printed circuit board, when the pendulum-shaped antenna is installed onto a printed circuit board of a wireless electronic product. The pendulum-shaped microstrip antenna structure comprises a signal feeding portion and an antenna portion sequentially installed in the direction from the printed circuit board to its distal end, and the pendulum-shaped antenna is extended outward, so that the current transmitted from the pendulum-shaped antenna can be distributed uniformly onto the signal feeding portion and the antenna portion to achieve the effects of improving the bandwidth of the pendulum-shaped antenna, reducing the feeding inductance, and providing sufficient bandwidth.

To make it easier for our examiner to understand the objective, technical characteristics and effects of the present invention, preferred embodiment will be described with accompanying drawings as follows:

### BRIEF DESCRIPTION OF THE DRAWINGS

FIG. 1 is a schematic view of a conventional chip antenna;

FIG. 2 is a schematic view of another conventional chip antenna;

FIG. 3A is a schematic view of a conventional circular antenna;

FIG. 3B is a schematic view of a conventional horn-shaped antenna;

FIG. 4 is a graph of actual testing data of a conventional horn-shaped antenna;

FIG. 5 is a schematic view of a multi-channel feed line of a conventional antenna unit;

FIG. 6 is a planar view of a pendulum-shaped antenna of the present invention;

FIG. 7 is a planar view of a preferred embodiment of the present invention; and

FIG. 8 is a graph of actual testing data of a preferred embodiment of the present invention.

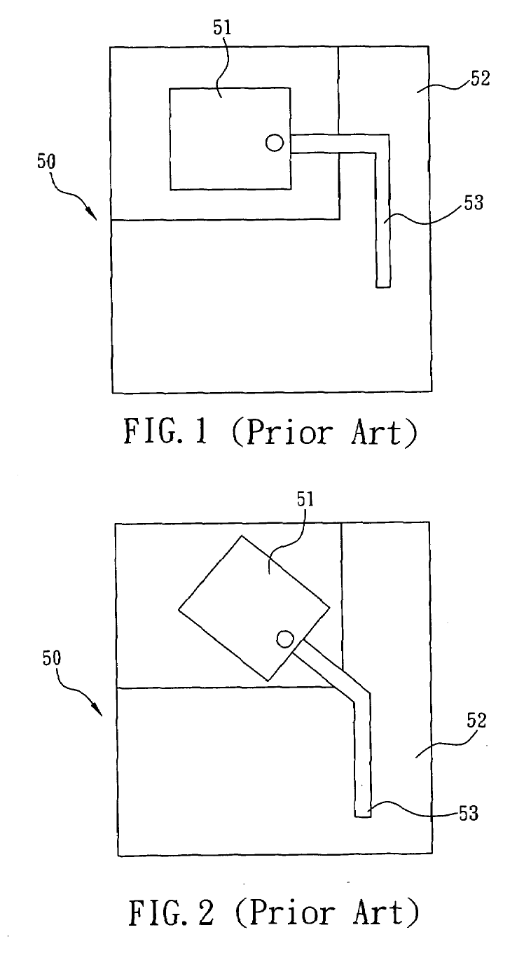

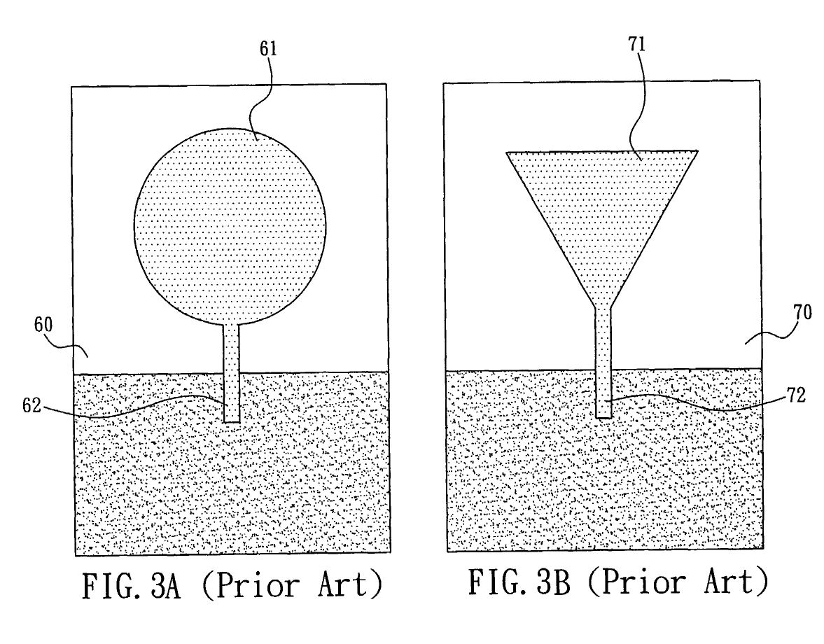

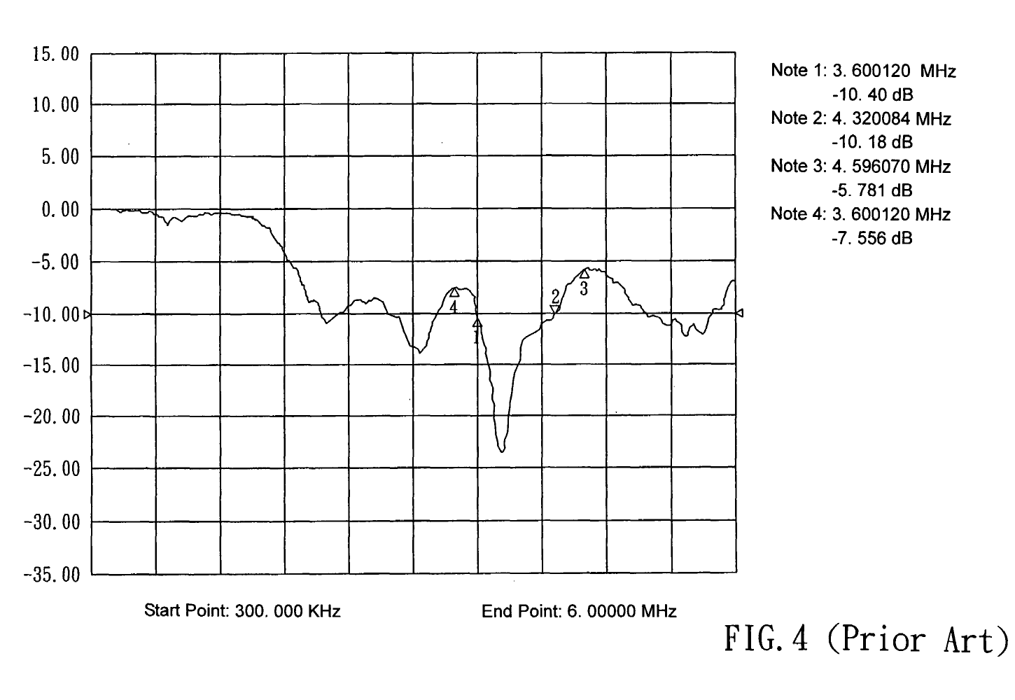

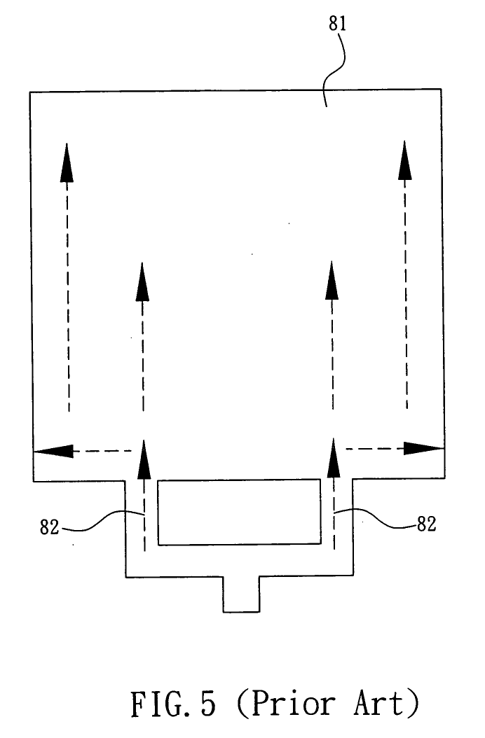

### DETAILED DESCRIPTION OF THE PREFERRED EMBODIMENTS

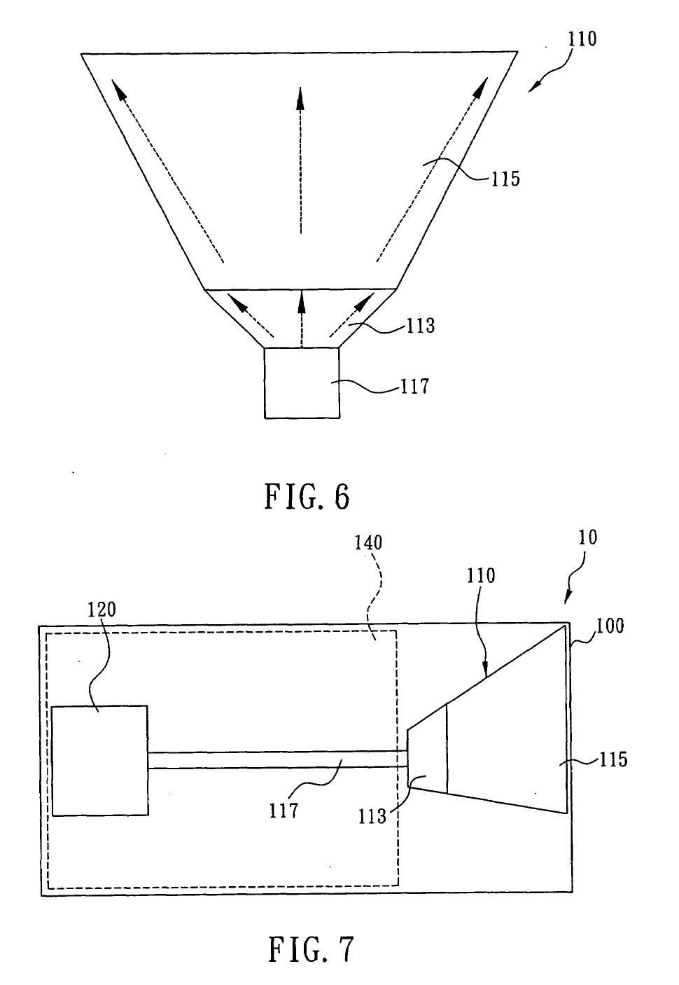

Referring to FIGS. 6 and 7 for a pendulum-shaped microstrip antenna structure of the present invention, the pendulum-shaped antenna 110 in the form of a metal microstrip is installed onto a printed circuit board 100 of a wireless electronic product by a printed circuit manufacturing technology, so that the pendulum-shaped antenna 110a is manufactured at an appropriate position on a surface of the printed circuit board 100, and the printed circuit board 100 further installs a control circuit and required components of a wireless electronic product, and the pendulum-shaped antenna 110 includes a signal feeding portion 113 and an antenna portion 115, and both signal feeding portion 113 and antenna portion 115 are in a trapezium shape, but the area of the antenna portion 115 is larger than the area of the signal feeding portion 113, such that a shorter side of the antenna portion 115 is connected to a longer side of the signal feeding portion 113 to form the pendulum-shaped antenna 110. With the characteristic of the pendulum-shaped antenna 110 being extended outward, the current transmitted from the pendulum-shaped antenna 110 can be distributed uniformly on the signal feeding portion 113 and the antenna portion 115 to achieve the effects of improving the feeding bandwidth of the pendulum-shaped antenna 110, reducing the feeding inductance and providing sufficient bandwidth.

Referring to FIG. 7 for a preferred embodiment of the present invention, a wireless USB network product 10 (such as a USB wireless network card) is used for illustration, and a printed circuit board 100 of the wireless USB network product 10 has the aforementioned pendulum-shaped antenna 110 and also includes a USB interface module 120, such that the USB interface module 120 of the wireless USB network product 10 can be connected to an electronic product (such as a mobile phone or a computer) by a USB connector (not shown in the figure), and a signal strip 117 made of a metal microstrip is passed through a ground surface 140 in the printed circuit board 100 and connected to a shorter side of the signal feeding portion 113, and the current transmitted from the pendulum-shaped antenna 110 can be distributed uniformly on the antenna portion 115 and the signal feeding portion 113, or an external current introduced to the pendulum-shaped antenna 110 can be received uniformly by the antenna portion 115.

In addition, the bandwidth of the pendulum-shaped antenna 110 of the wireless USB network product 10 not only covers a range of 3.1 GHz˜4.8 GHz set by a wireless USB (WUSB) specification that adopts a ultra wideband (UWB) technology, but also includes a bandwidth of 2.4 GHz set by the 802.11g wireless area network specification.

In the design accordance with the present invention, the metal microstrip line can be used to replace the traditional coaxial cable for feeding electric waves, and the pendulum-shaped antenna 110 in the form of a metal microstrip can be installed directly onto the printed circuit board 100 while manufacturing the printed circuit board 100. Therefore, the invention not only comes with a simple structure and an easy manufacture, but also lowers the cost effectively for mass production. The bandwidth of the manufactured pendulum-shaped antenna 110 used within its coefficient of reflection covers a range of 3000 MHz (from 1.91 GHz to 4.96 GHz), and thus the invention can improve the system performance of the wireless USB network product 10 effectively. Since the antenna portion 115 is extended to a side to improve the feeding bandwidth, a circuit designer of the wireless USB network product 10 can adjust the length of an external side of the pendulum-shaped antenna 110 and the length of an end of the signal strip 117 proximate to the signal feeding portion 113 according to actual requirements to control the gain of the pendulum-shaped antenna 110 and change the original bandwidth, when the pendulum-shaped antenna 110 is manufactured,

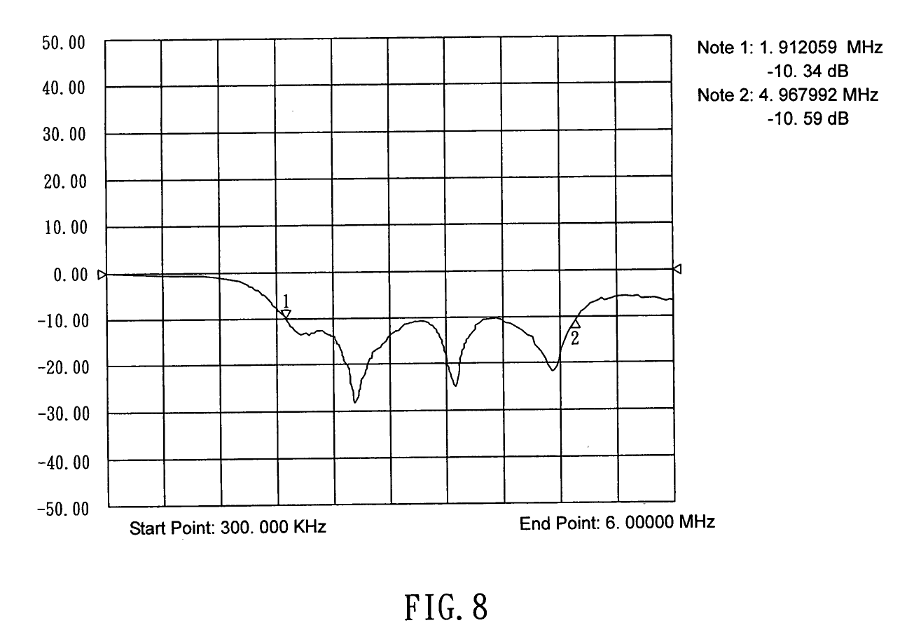

In the design accordance with the foregoing preferred embodiment of the present invention, the pendulum-shaped antenna 110 is installed onto a printed circuit board 100 and tested by a network analyzer, and the test result is shown in FIG. 8, wherein the pendulum-shaped antenna 110 has a good frequency response lower than the standard −10.00 dB at the bandwidths of 1910 MHz and 4960 MHz. Therefore, the present invention can be used to install the pendulum-shaped antenna 110 directly at a side of printed circuit board 100, if a wireless USB network product 10 needs to use a wireless network protocol or a wireless personal network. The invention provides a simple structure, a sufficient wideband range, and an enhanced system performance of the wireless electronic product.

The present invention has been described with a preferred embodiment thereof and it is understood that many changes and modifications in the described embodiment can be carried out without departing from the scope and the spirit of the invention that is intended to be limited only by the appended claims.

1. A pendulum-shaped microstrip antenna assembly for wireless communication, comprising:
a printed circuit board, having a control circuit and required components installed on said printed circuit board;
an antenna component consisted of, a pendulum-shaped metal microstrip,
wherein said pendulum-shaped metal microstrip including a trapezium-shaped signal feeding portion and a trapezium-shaped antenna portion, said trapezium-shaped signal feeding portion is smaller than the said trapezium-shaped antenna portion, and said trapezium-shaped signal feeding portion's longer side connects to said trapezium-shaped antenna portion's shorter side; and
wherein said antenna component transmitting current uniformly with shape of said signal feeding portion and said antenna portion.

2. The pendulum-shaped microstrip antenna assembly of claim 1, wherein said antenna component is symmetrical on both left and right sides of said printed circuit board.

3. The pendulum-shaped microstrip antenna assembly of claim 1, wherein said antenna component is asymmetrical on both left and right sides of said printed circuit board.

4. (canceled)

5. (canceled)

6. (canceled)

7. (canceled)

8. The pendulum-shaped microstrip antenna assembly of claim 2, wherein said printed circuit board further includes a USB interface module connected to said trapezium-shaped signal feeding portion by a signal strip.

9. The pendulum-shaped microstrip antenna assembly of claim 3, wherein said printed circuit board further includes a USB interface module connected to said trapezium-shaped signal feeding portion by a signal strip.

10. The pendulum-shaped microstrip antenna assembly of claim 8, wherein said signal strip is a metal microstrip.

11. The pendulum-shaped microstrip antenna assembly of claim 9, wherein said signal strip is a metal microstrip.
